(19) United States
(12) Patent Application Publication
(10) Pub. No.: US 2023/0037139 A1
(43) Pub. Date: Feb. 2, 2023

(54) BATTERY MODULE

(71) Applicant: SAMSUNG SDI CO., LTD., Yongin-si (KR)

(72) Inventor: Jong-Chan HAN, Yongin-si (KR)

(21) Appl. No.: 17/872,275

(22) Filed: Jul. 25, 2022

(30) Foreign Application Priority Data
Jul. 26, 2021 (KR) 10-2021-0098066

(51) Int. Cl. H01M 50/503; H01M 50/507

(52) U.S. Cl. CPC H01M 50/503; H01M 50/507

(57) ABSTRACT

A battery module includes battery cells, a first connection member connecting first terminals of the battery cells to each other and connected to a first common node, and a second connection member connecting second terminals of the battery cells to each other and connected to a second common node. The first common node is adjacent to a first battery cell between first and second battery cells at the outermost periphery of the battery cells. The second common node is adjacent to the second battery cell between the first and second battery cells. The first connection member is configured such that as the distance from the first common node is increased, a resistance for unit length is gradually increased. The second connection member is configured such that as the distance from the second common node is increased, a resistance for unit length is gradually increased.

### CROSS-REFERENCE TO RELATED APPLICATION

This application claims priority to and the benefit of Korean Patent Application No. 10-2021-0098066 filed in the Korean Intellectual Property Office on Jul. 26, 2021, the entire contents of which are incorporated herein by reference.

### BACKGROUND

### 1. Field

Embodiments relate to a battery module.

### 2. Description of the Related Art

A secondary battery may be repeatedly charged and discharged, and thus the secondary battery is different from a primary battery which just non-reversibly converts a chemical material into electrical energy. A secondary battery with a relatively low capacity may be used for a power device of a small electronic device such as a portable phone, a laptop computer, or a camcorder, and a secondary battery with a relatively high capacity may be used for a power device of an electric vehicle.

It is desirable for an electric vehicle to use a battery with a high capacity to increase a driving distance. Accordingly, a battery module, configured by connecting a plurality of battery cells in series or in parallel, may be used for an electric vehicle. Particularly, in order to configure a battery module with a high capacity, a plurality of battery cells may be coupled in parallel.

The above information disclosed in this Background section is only for enhancement of understanding of the background of the invention, and therefore it may contain information that does not form the prior art that is already known in this country to a person of ordinary skill in the art.

### SUMMARY

According to an embodiment, a battery module includes a battery cell array which includes a plurality of battery cells, a first connection member electrically connecting first terminals of the plurality of battery cells to each other and connected to an external device by means of a first common node, and a second connection member electrically connecting second terminals of the plurality of battery cells to each other and connected to an external device by means of a second common node, in which the first common node is located to be adjacent to a first battery cell between first and second battery cells located at the outermost periphery of the battery cell array and the second common node is located to be adjacent to the second battery cell between the first and second battery cells, and the first connection member is configured such that as the distance from the first common node is increased, a resistance for unit length is gradually increased and the second connection member is configured such that as the distance from the second common node is increased, a resistance for unit length is gradually increased.

The first connection member includes a plurality of first connection resistors which is sequentially connected along an arrangement direction of the plurality of battery cells, each of the plurality of first connection resistors connects first terminals of two adjacent battery cells, and the plurality of first connection resistors is configured such that as the distance from the first common node is increased, the resistance is gradually increased.

The second connection member includes a plurality of second connection resistors which is sequentially connected along an arrangement direction of the plurality of battery cells, each of the plurality of second connection resistors connects second terminals of two adjacent battery cells, and the plurality of second connection resistors is configured such that as the distance from the second common node is increased, the resistance is gradually increased.

Resistances of the plurality of first connection resistors and the plurality of second connection resistors are determined so as to satisfy Equation 14:

R_{Bk}=((n−k)/k)R_{Tk} [Equation 14]

wherein, in Equation 14, n is a number of the plurality of battery cells, R_{Tk} is a first connection resistor which is in a k-th placement in a first direction which becomes farther from the first common node among the plurality of first connection resistors, and R_{Bk} is a second connection resistor in a k-th placement in the first direction among the plurality of second connection resistors.

The first connection member is formed such that as the distance from the first common node is increased, a width, a thickness, or a cross-section of the first connection member are gradually increased so that as the distance from the first common node is increased, a resistance for unit length is increased and the second connection member is formed such that as the distance from the second common node is increased, a width, a thickness, or a cross-section of the second connection member are gradually increased so that as the distance from the second common node is increased, a resistance for unit length is increased.

The first and second connection members are configured by a bus bar.

### BRIEF DESCRIPTION OF THE DRAWINGS

Features will become apparent to those of skill in the art by describing in detail example embodiments with reference to the attached drawings in which:

FIG. 1 schematically illustrates a battery module according to an example embodiment.

FIG. 2 illustrates an equivalent circuit of a battery module according to an example embodiment.

FIG. 3 is a view for explaining a current deviation resolving effect of a battery module according to an example embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey example implementations to those skilled in the art. Like reference numerals refer to like elements throughout.

In the present specification, the term “and/or” refers to all combinations or an arbitrary combination of a plurality of related listed items. When the example embodiments are described using “can” or “may”, it refers to at least one example embodiment of “the present invention. In the following description of an example embodiment, terms in the singular form may include the plural form unless the context states otherwise.

In this specification, terms including ordinal numbers such as “first,” “second,” or “third” are used to explain various components, but the components are not limited by these terms. These terms are used only to distinguish one component from the other component. For example, without departing the scope, the second component may be referred to as a first component and likewise, the first component may be referred to as the second component.

Further, a size and a thickness of each composition illustrated in the drawing are arbitrarily illustrated for the convenience of description so that the example embodiments are not necessarily limited those illustrated in the drawing. In the drawings, in order to clearly express various layers and regions, a thickness and the area may be exaggerated.

In the present specification, when it is described that one component or layer is “connected” or “coupled” “on” the other component or layer, it means that one component may be formed on the other component directly or with one or more other components or layers interposed therebetween. Further, when it is described that one component or layer is placed “between” two components or layers, it should be understood that one component or layer is the only one component or layer between two components or layers or there may be one or more interposed elements or layers. Further, when two components are electrically connected, it means that two components are directly connected or connected with the other component therebetween. The other component may include a switch, a resistor, and a capacitor. In the description of the example embodiments, “connect” means “electrically connect” when there is no expression of direct connection.

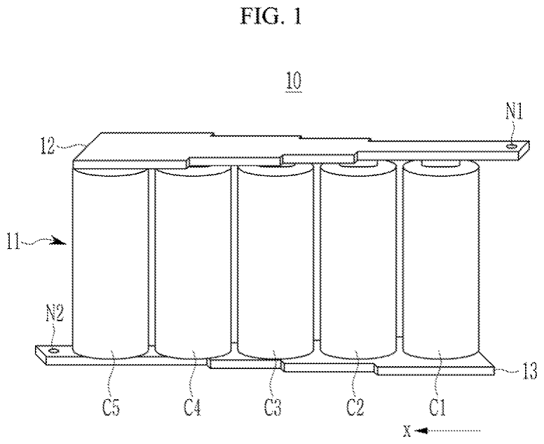

FIG. 1 schematically illustrates a battery module according to an example embodiment.

Referring to FIG. 1, a battery module 10 may include a battery cell array 11, and first and second connection members 12 and 13.

The battery cell array 11 may include a plurality of battery cells C1 to C5 sequentially disposed along a predetermined direction (for example, an x direction of FIG. 1).

In FIG. 1, for the convenience of description, it is illustrated that the battery cell array 11 includes five battery cells as an example. However, the number of battery cells included in the battery cell array 11 may be larger or smaller than five.

The first connection member 12 may be coupled to positive terminals of the plurality of battery cells (C1 to C5) to electrically connect the positive terminals of the plurality of battery cells (C1 to C5). The second connection member 13 may be coupled to negative terminals of the plurality of battery cells (C1 to C5) to electrically connect the negative terminals of the plurality of battery cells (C1 to C5). Accordingly, the plurality of battery cells (C1 to C5) may be connected in parallel between the first connection member 12 and the second connection member 13.

The first and second connection members 12 and 13 may each be configured by a conductive member such as a bus bar.

The first and second connection members 12 and 13 may respectively include a first common node N1 and a second common node N2. The first and second common nodes N1 and N2 may be electrically connected to an external device (for example, a charger or a load). In the present example embodiment, the first and second common nodes N1 and N2 are current exits of the first and second connection members 12 and 13 so that a current flow between the first and second connection members 12 and 13 and the external device may be formed by the first and second common nodes N1 and N2.

The first and second common nodes N1 and N2 may be located in opposite directions with respect to a center portion of the battery cell array 11. The center portion of the battery cell array 11 may refer to a center portion of an arrangement direction (the x-direction of FIG. 1) of the battery cells (C1 to C5) which configure the battery cell array 11.

The first common node N1 may be located to be adjacent to a battery cell C1, and may be connected between two outermost battery cells C1 and C5 of the battery cell array 11. The second common node N2 may be located to be adjacent to a battery cell C5, and may be connected between two outermost battery cells C1 and C5 of the second common node N2.

The first connection member 12 may be configured such that, as the distance from the first common node N1 is increased, the resistance for unit length gradually increases and, as the distance from the first common node N1 is reduced, the resistance for unit length is gradually reduced.

The second connection member 13 may be configured such that, as the distance from the second common node N2 is increased, the resistance for unit length gradually increases and, as the distance from the second common node N2 is reduced, the resistance for unit length is gradually reduced.

In FIG. 1, the length direction of the first and second connection members 12 and 13 corresponds to the arrangement direction (x-direction) of the battery cells (C1 to C5).

Referring to FIG. 1, the first connection member 12 is configured such that, as distance from the first common node N1 is increased, the width gradually increases so that, as the distance from the first common node N1 is increased, the resistance for unit length may be gradually increased. Further, the second connection member 13 is formed such that, as distance from the second common node N2 is increased, the width gradually increases so that, as the distance from the second common node N2 is increased, the resistance for unit length may be gradually increased.

In FIG. 1, by way of example, it is illustrated that in order to gradually increase/decrease the resistance for unit length of the first and second connection members 12 and 13, widths of the first and second connection members 12 and 13 are gradually increased/decreased, but, according to another example embodiment, in order to gradually increase/decrease the resistance for unit length of the first and second connection members 12 and 13, the heights or cross-sections of the first and second connection members 12 and 13 may be gradually increased/decreased.

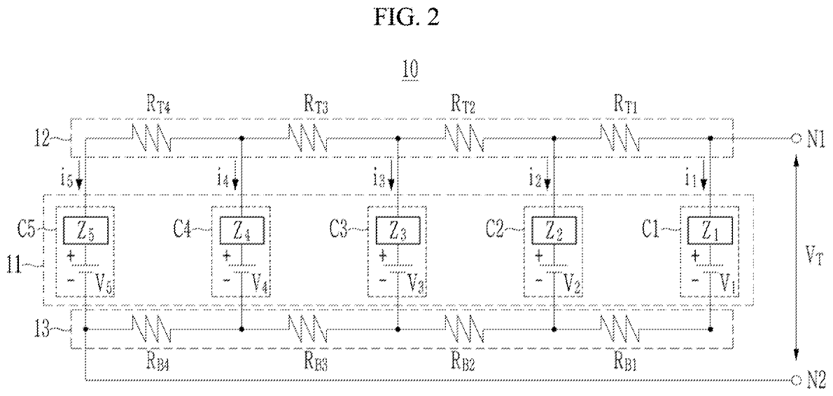

Hereinafter, a method of determining a resistance according to the positions of the first connection member 12 and the second connection member 13 will be described in detail with reference to FIG. 2.

FIG. 2 illustrates an equivalent circuit of a battery module of FIG. 1. FIG. 2 illustrates that a common voltage VT is applied to the battery cell array 11 by means of the first and second common nodes N1 and N2.

In FIG. 2, currents flowing through the battery cells (C1 to C5) are i₁, i₂, i₃, i₄, and i₅.

Also, open voltages of the battery cells (C1 to C5) are V_{oc1}, V_{oc2}, V_{oc3}, V_{oc4}, and V_{oc5}. Also, internal resistances of the battery cells (C1 to C5) are Z₁, Z₂, Z₃, Z₄, and Z₅.

Referring to FIG. 2, the first connection member 12 may include a plurality of connection resistors R_{T1} to R_{T4} sequentially connected in series along an arrangement direction (see the x-direction of FIG. 1) of the battery cells C1 to C5. Each of the plurality of first connection resistors R_{T1} to R_{T4} electrically connects the positive terminals of two adjacent battery cells.

The second connection member 13 may include a plurality of second connection resistors R_{B1} to R_{B4} sequentially connected in series along the arrangement direction (the x-direction) of the battery cells C1 to C5. Each of the plurality of second connection resistors R_{B1} to R_{B4} may electrically connect negative terminals of two adjacent battery cells.

R_{T1} is a connection resistor that connects the positive terminals of the first and second battery cells C1 and C2, and R_{B1} is a connection resistor that connects the negative terminals of the first and second battery cells C1 and C2.

R_{T2} is a connection resistor that connects the positive terminals of the second and third battery cells C2 and C3, and R_{B2} is a connection resistor that connects the negative terminals of the second and third battery cells C2 and C3.

R_{T3} is a connection resistor that connects the positive terminals of the third and fourth battery cells C3 and C4, and R_{B3} is a connection resistor that connects the negative terminals of the third and fourth battery cells C3 and C4.

R_{T4} is a connection resistor that connects the positive terminals of the fourth and fifth battery cells C4 and C5, and R_{B4} is a connection resistor that connects the negative terminals of the fourth and fifth battery cells C4 and C5.

The plurality of first connection resistors R_{T1} to R_{T4} is configured such that the resistance is gradually increased along the arrangement direction (the x-direction) of the battery cells C1 to C5. That is, the plurality of first connection resistances R_{T1} to R_{T4} may be configured such that, as the distance from the first common node N1 is increased, the resistance is gradually increased and, as the distance from the first common node N1 is decreased, the resistance is gradually decreased.

The plurality of second connection resistors R_{B1} to R_{B4} is configured such that the resistance is gradually decreased along the arrangement direction (the x-direction) of the battery cells C1 to C5. That is, the plurality of second connection resistors R_{B1} to R_{B4} may be configured such that, as the distance from the second common node N2 is increased, the resistance is gradually increased and, as the distance from the second common node N2 is decreased, the resistance is gradually decreased.

As described with reference to FIG. 1, the first and second connection resistors R_{T1} to R_{T4}, and R_{B1} to R_{B4} may control the resistance by way of adjusting a physical shape of the corresponding connection members 12 and 13.

Hereinafter, the method for determining resistances of the first and second connection resistors R_{T1} to R_{T4}, R_{B1} to R_{B4} according to the position, e.g., the position in the battery cell array 11, will be described in detail with reference to the following Equations.

When it is assumed that the battery cells C1 to C5 have the same characteristic (Z₁=Z₂=Z₃=Z₄=Z₅, V_{oc1}=V_{oc2}=V_{oc3}=V_{oc4}=V_{oc5}), the common voltage V_{T} may be represented by Equations 1 to 5.

V_{T}=i₁Z₁+V_{oc1}+i₁R_{B1}+(i₁+i₂)R_{B2}+(i₁+i₂+i₃)R_{B3}+(i₁30 i₂+i₃+i₄)R_{B4} [Equation 1]

V_{T}=i₂Z₂+V_{oc2}+(i₂+i₃+i₄+i₅)R_{T}+(i₁+i₂)R_{B2}+(i₁+i₂+i₃)R_{B3}+(i₁+i₂+i₃+i₄)R_{B4} [Equation 2]

V_{T}=i₃Z₃+V_{oc3}+(i₂+i₃+i₄+i₅)R_{T1}+(i₃+i₄+i₅)R_{T2}+(i₁+i₂+i₃)R_{B3}+(i₁+i₂+i₃+i₄)R_{B4} [Equation 3]

V_{T}=i₄Z₄+V_{oc4}+(i₂+i₃+i₄+i₅)R_{T1}+(i₃+i₄+i₅)R_{T2}+(i₄+i₅)R_{T3}+(i₁+i₂+i₃+i₄)R_{B4} [Equation 4]

V_{T}=i₅Z₅+V_{oc5}+(i₂+i₃+i₄+i₅)R_{T1}+(i₃+i₄+i₅)R_{T2}+(i₄+i₅)R_{T3}+i₅R_{T4} [Equation 5]

When it is assumed that the same current flows through all the battery cells C1 to C5, if Equation 1 is subtracted from Equation 2, the following Equation 6 may be represented.

(i₂Z₂+V_{oc2}+(i₂+i₃+i₄+i₅)R_{T1}+(i₁+i₂)R_{B2}+(i₁+i₂+i₃)R_{B3}+(i₁+i₂+i₃+i₄)R_{B4})−(i₁Z₁+V_{oc1}+i₁R_{B1}+(i₁+i₂)R_{B2}+(i₁+i₂+i₃)R_{B3}+(i₁+i₂+i₃+i₄)R_{B4})=i₁R_{B1}−(i₂i₃i₄+i₅)R_{T1}=0 [Equation 6]

From the above-mentioned Equation 6, a relational equation between two connection resistors R_{B1} and R_{T1} may be derived by the following Equation 7.

R_{B1}=((i₂+i₃+i₄+i₅)/i₁)R_{T1}=4R_{T1} [Equation 7]

Further, when Equation 2 is subtracted from Equation 3, the result will be represented by Equation 8.

(i₃Z₃+V_{oc3}+(i₂+i₃+i₄+i₅)R_{T1}+(i₃+i₄+i₅)R_{T2}+(i₁+i₂+i₃)R_{B3}+(i₁±i₂+i₃+i₄)R_{B4})−(i₂Z₂V_{oc2}+(i₂+i₃+i₄+i₅)R_{T1}+(i₁+i₂)R_{B2}+(i₁+i₂+i₃)R_{B3}+(i₁+i₂+i₃+i₄)R_{B4})=(i₃+i₄+i₅)R_{T2}−(i₁+i₂)R_{B2} [Equation 8]

From Equation 8, a relational equation between two connection resistors R_{B2} and R_{T2} may be derived as the following Equation 9.

R_{B2}=((i₃+i₄+i₅)/(i₁+i₂))R_{T2}=3/2R_{T2} [Equation 9]

Further, when Equation 3 is subtracted from Equation 4, the result will be expressed by the following Equation 10.

(i₄Z₄+V_{oc4}+(i₂+i₃+i₄+i₅)R_{T1}+(i₃+i₄+i₅)R_{T2}+(i₄+i₅)R_{T3}+(i₁+i₂+i₃+i₄)R_{B4})−(i₃Z₃+V_{oc3}+(i₂+i₃+i₄+i₅)R_{T1}+(i₃+i₄+i₅)R_{T2}+(i₁+i₂+i₃)R_{B3}+(i₁+i₂+i₃+i₄)R_{B4})=((i₄+i₅)R_{T3})−((i₁+i₂+i₃)R_{B3}) [Equation 10]

From Equation 10, a relational Equation between two connection resistors R_{B3} and R_{T3} is derived as the following Equation 11.

R_{B3}=((i₄+i₅)/(i₁+i₂+i₃))R_{T3}=2/3R_{T3} [Equation 11]

Further, when Equation 4 is subtracted from Equation 5, the result will be expressed by the following Equation 12.

(i₅Z₅+V_{oc5}+(i₂+i₃+i₄+i₅)R_{T1}+(i₃+i₄+i₅)R_{T2}+(i₄+i₅)R_{T3}+i₅R_{T4})−(i₄Z₄+V_{oc4}+(i₂+i₃+i₄+i₅)R_{T1}+(i₃+i₄+i₅)R_{T2}+(i₄+i₅)R_{T3}+(i₁+i₂+i₃+i₄)R_{B4})=(i₅R_{T4})−((i₁+i₂+i₃+i₄)R_{B4}) [Equation 12]

From Equation 12, a relational Equation between two connection resistors R_{B4} and R_{T4} is derived as the following Equation 13.

R_{B4}=(i₅/(i₁+i₂+i₃+i₄))R_{T3}=1/4R_{T4} [Equation 13]

When Equation 7 (R_{B1}=4R_{T1}), Equation 9 (R_{B2}=3/2R_{T2}), Equation 11 (R_{B3}=2/3R_{T3}), and Equation 13 (R_{B4}=1/4R_{T4}) are generalized, the result will be expressed by the following Equation 14.

R_{Bk}=((n−k)/k)R_{Tk} [Equation 14]

In Equation 14, n is a number of battery cells C1 to C5 which configure the battery cell array 11, R_{Tk} represents a k-th first connection resistor with respect to the arrangement direction (the x-direction of FIG. 1) of the battery cells C1 to C5 among a plurality of first connection resistors R_{T1} to R_{T4} which configures the first connection member 12. Further, R_{Bk} represents a k-th second connection resistor with respect to the arrangement direction (the x-direction of FIG. 1) of the battery cells C1 to C5, among a plurality of second connection resistors R_{B1} to R_{B4} which configures the second connection member 13.

In the present example embodiment, resistances of the first and second connection resistors R_{T1} to R_{T4} and R_{B1} to R_{B4} are determined so as to satisfy the above Equation 14. Further, shapes of the first and second connection members 12 and 13 may be adjusted based on the resistances of the first and second connection resistors R_{T1} to R_{T4}, R_{B1} to R_{B4}.

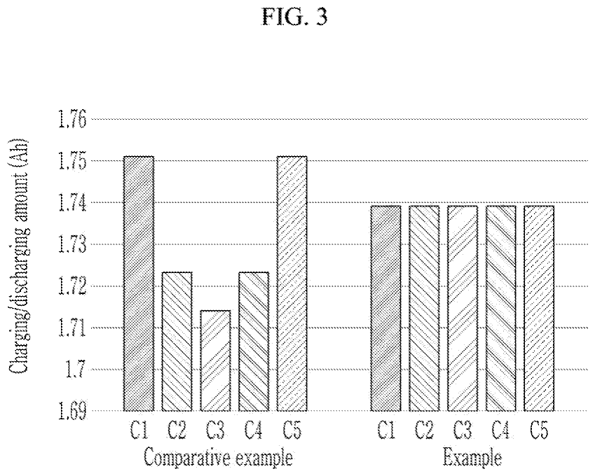

FIG. 3 is a view for explaining a current deviation resolving effect of a battery module according to an example embodiment.

In FIG. 3, Comparative Example is a result obtained by simulating a charged and discharged amount (Ah) of each battery cell C1 to C5 by configuring resistances of the first and second connection resistors R_{T1} to R_{T4}, R_{B1} to R_{B4} to be equal to each other (R_{T1}=R_{T2}=R_{T3}=R_{T4}=R_{B1}=R_{B2}=R_{B3}=R_{B4}−1.0 mΩ).

Further, Example is a result obtained by simulating a charged and discharged amount (Ah) of each battery cell C1 to C5 by configuring the resistances of the first and second connection resistors R_{T1} to R_{T4}, R_{B1} to R_{B4} to satisfy the above Equation 14 (R_{T1}=0.4 mΩ, R_{T2}=0.8 mΩ, R_{T3}=1.2 mΩ, R_{T4}=1.6 mΩ, R_{B1}=1.6 mΩ, R_{B2}=1.2 mΩ, R_{B3}=0.8 mΩ, R_{B4}=0.4 mΩ).

The Comparative Example and Example of FIG. 3 are results obtained by simulating to charge and discharge with the same current and voltage for the same time.

The following Table 1 represents the graph of FIG. 3 and (max-min) represents a value obtained by subtracting a charged/discharged amount (min) of a battery cell with the smallest charged/discharged amount from a charged/discharged amount (max) of the battery cell with the largest charged/discharged amount.

TABLE 1

| | C1 | C2 | C3 | C4 | C5 | (Max − min) |
|---|---|---|---|---|---|---|
| Comparative Example | 1.751 | 1.723 | 1.714 | 1.723 | 1.751 | 0.04 |
| Example | 1.739 | 1.739 | 1.739 | 1.739 | 1.739 | 0 |

Referring to FIG. 3 and Table 1, when the first and second connection resistors R_{T1} to R_{T4}, R_{B1} to R_{B4} are configured to have the same resistance, there may be a deviation in the charged/discharged amount due to a current deviation of the battery cells C1 to C5. In contrast, as described in Example, where the resistances of the first and second connection resistors R_{T1} to R_{T4}, R_{B1} to R_{B4} are configured to satisfy Equation 14, the current deviation of the battery cells C1 to C5 is resolved so that the charged/discharged amount of all the battery cells C1, C2, and C3 may be equal to each other.

According to the above Example, as described above, the current deviation between the battery cells is removed so that a maximum allowable current of the battery module may be increased. Further, a temperature deviation between the battery cells due to the current deviation, as well as a lifespan deviation between the battery cells due to the current and temperature deviation, may be reduced.

An electronic or electrical device according to example embodiments described herein and/or any other related device or component may be implemented using any suitable hardware, firmware (for example, application-specific integrated circuit), software, or a combination of software, firmware, and hardware. For example, various components of the device may be formed on one integrated circuit (IC) chip or an individual IC chip. Further, various components of the device may be implemented on a flexible printed circuit film, a tape carrier package (TCP), a printed circuit board (PCB), or one substrate. An electrical connection or interconnection described in the present specification may be implemented by wiring lines or conductive elements on a PCB or another part of a circuit carrier. The conductive element may include a metallization such as surface metallizations and/or pins and may include conductive polymers or ceramics. Further, the electrical energy may be transmitted by means of wireless connection using electromagnetic emission or light.

Further, various components of this device may be processes or threads which are executed on one or more processors, executed in one or more computing devices, execute a computer program instruction, and interact with the other system components so as to perform various functions described herein. The computer program instruction is stored in a memory which can be implemented in a computing device using a standard memory device such as a random access memory (RAM). The computer program instruction may also be stored in a non-transitory computer readable medium such as a CD-ROM or a flash drive.

As described above, example embodiments may provide a battery module in which battery cells are uniformly charged or discharged by minimizing a current variation between battery cells coupled in parallel. According to an example embodiment, a current deviation of battery cells that are connected in parallel may be minimized to uniformly charge/discharge the battery cells.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

### DESCRIPTION OF SYMBOLS

10: Battery module

11: Battery cell array

12: First connection member

13: Second connection member

C1 to C5: Battery cell

N1: First common node

N2: Second common node

R_{T1} to R_{T4}: First connection resistor

R_{B1} to R_{B4}: Second connection resistor

What is claimed is:

1. A battery module, comprising:
a battery cell array which includes a plurality of battery cells;
a first connection member electrically connecting first terminals of the plurality of battery cells to each other, and connected to an external device by a first common node; and
a second connection member electrically connecting second terminals of the plurality of battery cells to each other, and connected to an external device by a second common node, wherein:
the battery cell array includes a first battery cell at a first outermost periphery of the battery cell array, and a second battery cell at an opposite outermost periphery of the battery cell array,
the first common node is located adjacent to the first battery cell, and is connected between the first battery cell and the second battery cell,
the second common node is located adjacent to the second battery cell, and is connected between the first battery cell and the second battery cell,
the first connection member is configured such that as a distance from the first common node is increased, a resistance for unit length is gradually increased, and
the second connection member is configured such that as a distance from the second common node is increased, a resistance for unit length is gradually increased.

2. The battery module as claimed in claim 1, wherein:
the first connection member includes a plurality of first connection resistors sequentially connected along an arrangement direction of the plurality of battery cells,
each of the plurality of first connection resistors connects first terminals of two adjacent battery cells, and
the plurality of first connection resistors is configured such that as the distance from the first common node is increased, respective resistances of the first connection resistors are gradually increased.

3. The battery module as claimed in claim 2, wherein:
the second connection member includes a plurality of second connection resistors sequentially connected along an arrangement direction of the plurality of battery cells,
each of the plurality of second connection resistors connects second terminals of two adjacent battery cells, and
the plurality of second connection resistors is configured such that as the distance from the second common node is increased, respective resistances of the second connection resistors are gradually increased.

4. The battery module as claimed in claim 3, wherein the resistances of the plurality of first connection resistors and the plurality of second connection resistors are determined so as to satisfy Equation 14:
R_{Bk}=((n−k)/k)R_{Tk} [Equation 14]
wherein, in Equation 14,
n is a number of battery cells in the plurality of battery cells,
k is an integer from 1 to n−1, inclusive,
R_{Tk} is resistance of a first connection resistor which is in a k-th placement in a first direction which becomes farther from the first common node among the plurality of first connection resistors, and
R_{Bk} is resistance of a second connection resistor in the k-th placement in the first direction among the plurality of second connection resistors.

5. The battery module as claimed in claim 1, wherein:
the first connection member is formed such that as the distance from the first common node is increased, a width, a thickness, or a cross-section of the first connection member are gradually increased so that as the distance from the first common node is increased, a resistance for unit length is increased, and
the second connection member is formed such that as the distance from the second common node is increased, a width, a thickness, or a cross-section of the second connection member are gradually increased so that as the distance from the second common node is increased, a resistance for unit length is increased.

6. The battery module as claimed in claim 1, wherein the first and second connection members are each configured by a bus bar.
